(19) United States
(12) Patent Application Publication
(10) Pub. No.: US 2014/0148992 A1
(43) Pub. Date: May 29, 2014

(54) METHOD FOR SENSOR THRESHOLD COMPENSATION

(71) Applicant: Ford Global Technologies, Dearborn, MI (US)

(72) Inventors: Aric David Shaffer, Saline, MI (US); Vernon Richard Stempnik, Roseville, MI (US); Michael David Kane, Brighton, MI (US); Stephen Varghese Samuel, Troy, MI (US); Wangdong Luo, Auburn Hills, MI (US); Wilford Trent Yopp, Canton, MI (US)

(73) Assignee: Ford Global Technologies, Dearborn, MI (US)

(21) Appl. No.: 14/169,109

(22) Filed: Jan. 30, 2014

Related U.S. Application Data
(63) Continuation-in-part of application No. 13/691,788, filed on Dec. 1, 2012, now Pat. No. 8,676,438.
Application No. 13/691,788 is a continuation-in-part of application No. 13/563,150, filed on Jul. 31, 2012, now Pat. No. 8,682,523.

(51) Int. Cl. F02D 29/00

(52) U.S. Cl. CPC F02D 29/00
USPC 701/33.7

(57) ABSTRACT

A system and method for outputting outside air temperature information and signaling apparatus configured for outputting powertrain operating information, the system comprising instructions causing the at least one data processing device to determine a first instance of signal strength calibration for the ultrasonic sensor based on a last known instance of outside air temperature and a first instance of powertrain operating information, instructions causing the at least one data processing device to determine a vehicle operating condition requiring alteration of the signal strength calibration for the ultrasonic sensor, instructions for altering the signal strength calibration for the ultrasonic sensor and instructions for altering an outside air temperature to be displayed to a driver of the vehicle.

### CROSS REFERENCE TO RELATED APPLICATIONS

This continuation-in-part application claims priority to co-pending U.S. Non-provisional patent application Ser. No. 13/691,788; filed Dec. 1, 2012; entitled “Method and System for Implementing Ultrasonic Sensor Signal Strength Calibrations” now allowed which is a continuation-in-part of co-pending U.S. non-provisional patent application having Ser. No. 13/563,150; filed Jul. 31, 2012; entitled “Method and System for Implementing Ultrasonic Sensor Signal Strength Calibrations”; having a common application herewith; and being incorporated by reference herein in its entirely.

### TECHNICAL FIELD

The disclosure herein relates generally to utilization of ultrasonic sensor data in automotive applications and, more particularly, to temperature compensating for improving a performance of ultrasonic sensors in automotive applications.

### BACKGROUND

It is well known that ultrasonic sensors are used for many driver aid applications to assist vehicle drivers. In such automotive applications, ultrasonic sensors use sound waves that pass through air (i.e., a fluid medium) to determine that an object is present and to determine its distance. One driver aid application is to detect an object of concern that the driver might not be aware of when the vehicle is backing up. Another driver aid application is to assist the driver in determining that an appropriate parking spot is available when the vehicle is in Park Assist mode. These driver aid applications are accomplished by using a plurality of ultrasonic sensors to detect objects and determine distance between such object and the sensor(s). Providing required information for these and other types of driver aid applications can necessitate mounting one or more of such ultrasonic sensors in close proximity to an engine compartment of the vehicle. For example, it is becoming common for a plurality of ultrasonic sensors to be mounted on a front bumper of a vehicle in addition to the well-known mounting of a plurality of ultrasonic sensors in a rear bumper of the vehicle. However, unlike placement of the ultrasonic sensors in the rear bumper, ultrasonic sensors in the front bumper are typically exposed to heat from the engine compartment.

The ability of an ultrasonic sensor to detect objects and report their distance can be adversely impacted as the temperature of the outside air (i.e., temperature of outside air surrounding the vehicle) changes and/or temperature of the sensor(s) changes. For example, some ultrasonic sensors used in automotive applications begin exhibiting diminished object detection capability as the temperature of the sensor reaches about 40-50 degrees Celsius. To assist with mitigating such temperature based variability in sensing performance of such ultrasonic sensor(s), vehicle systems typically make use of the outside air temperature data that is used to display outside temperature to vehicle users to compensate for changes in temperature as it relates to ultrasonic sensor performance. The sensor used to determine the outside air temperature data (i.e., the outside air temperature sensor) can be located in or near to an engine compartment of a vehicle. For example, the outside air temperature sensor is often located on the grill or other forward structure of a vehicle. As a result, heat from an engine of the vehicle can affect accuracy of the ambient air temperature data provided by the outside air temperature sensor, especially when vehicle is standing still. To help prevent inaccuracies in outside air temperature data arising from engine heat, algorithms are used to counteract the effects of the engine heat by restricting the raise of the displayed outside air temperature. This restriction can result in an inaccurate estimation of the sensor's actual temperature.

Accordingly, temperature compensation for ultrasonic sensors can have a significant error that is highly undesirable because temperature of ultrasonic sensors and the temperature of the medium through which they sense objects affects signal strength calibrations (e.g., echo thresholds) applied when detecting an object. In order to increase the detection capabilities and reported distance of an object, ultrasonic sensors need to adjust their detection criteria and distance calculations as the temperature of air surrounding a vehicle (i.e., outside air temperature) changes and also as the temperature of the sensor changes. Therefore, a simple, effective and consistent approach for determining a temperature upon which such detection criteria and distance calculations adjustments can be based would be beneficial, desirable and useful.

### SUMMARY

A method for processing a signal representative of an outside air temperature to be displayed to a driver of the vehicle the includes providing a signal processing unit with a first instance of an outside air temperature, providing the signal processing unit with a first instance of powertrain operating information, determining a vehicle operating condition requiring alteration of the signal representative of an outside air temperature to be displayed, providing the signal processing unit with a second instance of the outside air temperature in response to determining the vehicle operating condition requiring alteration of the signal representative of the outside air temperature to be displayed, and displaying the second instance of the outside air temperature to the driver of the vehicle.

An electronic controller system in a vehicle having at least one data processing device coupled between an ultrasonic sensor, a signaling apparatus configured for outputting outside air temperature information and signaling apparatus configured for outputting powertrain operating information, the system comprising instructions causing the at least one data processing device to determine a first instance of signal strength calibration for the ultrasonic sensor based on a last known instance of outside air temperature and a first instance of powertrain operating information, instructions causing the at least one data processing device to determine a vehicle operating condition requiring alteration of the signal strength calibration for the ultrasonic sensor, instructions for altering the signal strength calibration for the ultrasonic sensor and instructions for altering an outside air temperature to be displayed to a driver of the vehicle.

A method for processing a signal representative of an outside air temperature to be displayed to a driver of a vehicle comprising the steps of receiving a first instance of an outside air temperature, setting a signal strength calibration and displaying an outside air temperature based on the first instance of the outside air temperature, receiving a vehicle road speed signal, receiving a second instance of outside air temperature, receiving a first instance of powertrain operating information, determining when a first vehicle speed condition has been met, setting the signal strength calibration and displaying an outside air temperature based on the second instance of the outside air temperature when the first vehicle speed condition has been met. When the first vehicle speed condition has not been met, determining when a second vehicle speed condition has been met, comparing the first instance of powertrain operating information to a predetermined threshold value, determining when the first instance of powertrain operating information exceeds the predetermined threshold value, displaying the first instance of the outside air temperature, determining when the first instance of powertrain operating information is at or below the predetermined threshold value, displaying the second instance of outside air temperature, comparing the second instance of outside air temperature to the first instance of outside air temperature, and setting the signal strength calibration and displaying an outside air temperature based on the second instance of the outside air temperature when the second vehicle speed condition has been met and the second instance of outside air temperature is less than the first instance of outside air temperature.

### DESCRIPTION OF DRAWINGS

FIG. 1 is a vehicle configured in accordance with the inventive subject matter.

FIG. 2 is a block diagram showing functional elements of the vehicle of FIG. 1.

FIG. 3 is a graph showing acoustic response characteristics for a signal outputted by the ultrasonic sensor of FIG. 1 corresponding to a first signal strength calibration with the ultrasonic sensor at a first temperature.

FIG. 4 is a graph showing acoustic response characteristics for a signal outputted by the ultrasonic sensor of FIG. 1 corresponding to the first signal strength calibration with the ultrasonic sensor at a second temperature.

FIG. 5 is a graph showing acoustic response characteristics for a signal outputted by the ultrasonic sensor of FIG. 1 corresponding to a second signal strength calibration with the ultrasonic sensor at the second temperature.

FIGS. 6A and 6B show a method for implementing ultrasonic sensor calibrating functionality.

FIGS. 7A and 7B show a method for implementing ultrasonic sensor calibrating functionality.

FIGS. 8A and 8B show a method for estimating and displaying an outside air temperature to a driver.

Elements and steps in the figures are illustrated for simplicity and clarity and have not necessarily been rendered according to any particular sequence. For example, steps that may be performed concurrently or in a different order are illustrated in the figures to help to improve understanding of embodiments of the inventive subject matter.

### DESCRIPTION OF INVENTION

While various aspects of the inventive subject matter are described with reference to a particular illustrative embodiment, the invention is not limited to such embodiments, and additional modifications, applications, and embodiments may be implemented without departing from the inventive subject matter. In the figures, like reference numbers will be used to illustrate the same components. Those skilled in the art will recognize that the various components set forth herein may be altered without varying from the scope of the inventive subject matter.

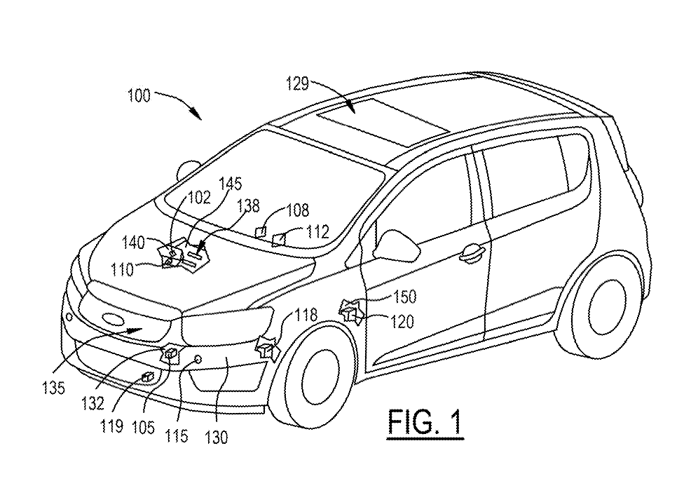

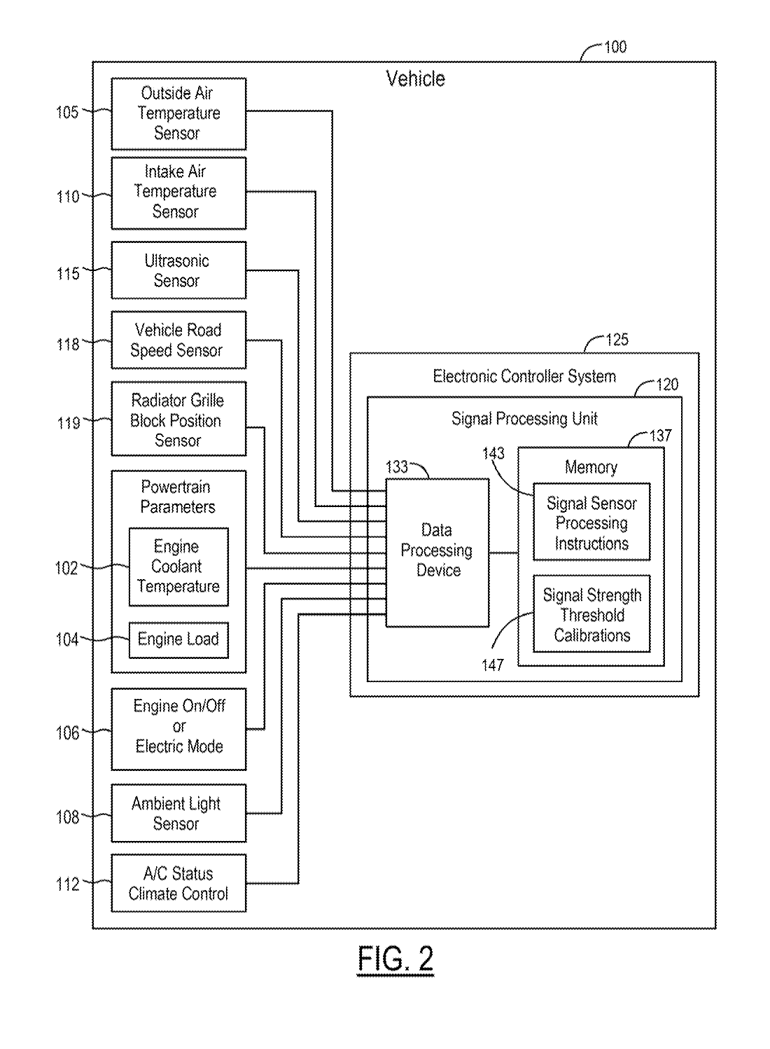

FIGS. 1 and 2 show a vehicle 100 configured in accordance with an embodiment of the inventive subject matter. Vehicle 100 includes an outside air temperature sensor 105, an intake air temperature sensor 110, an ultrasonic sensor 115, and a vehicle speed sensor 118. Vehicle 100 may also be equipped with a radiator grille block position sensor 119, an engine coolant temperature sensor 102, an engine load sensor 104, an electric mode sensor 106, an ambient light sensor 108 and an air conditioning status sensor in a climate control system 112.

The vehicle 100 is also equipped with a signal processing unit 120. The signal processing unit is connected to each of the outside air temperature sensor 105, the intake air temperature sensor 110, the ultrasonic sensor 115, the vehicle speed sensor 118, the engine coolant temperature sensor 102, the engine load sensor 104, the electric mode sensor 106, the ambient light sensor 108 and an air conditioning status sensor in the climate control system 112. The signal processing unit 120 may be an integral component of an electronic controller system 125 (shown in FIG. 2) that implements and supports control of a variety of systems on the vehicle 100.

The outside air temperature sensor 105 may be mounted at a location between an occupant cabin 129 of the vehicle 100 and a front bumper cover 130 of the vehicle 100, such as on a bumper cover support 132 or immediately adjacent to a front grill opening 135 of the vehicle 100. Mounting locations for the outside air temperature sensor 105 may vary and are not necessarily limited to the examples described herein. The outside air temperature sensor 105 outputs a signal that is representative of a temperature of air surrounding the vehicle 100. In particular, the outside air temperature sensor 105 outputs a signal representative of a temperature of air surrounding or flowing over a front bumper cover 130 of vehicle 100 (i.e., at least a portion of this air surrounds the occupant cabin 129). When the vehicle 100 is at or above a sufficient road speed for a suitable duration of time, the outside air temperature sensor 105 is outputting a signal corresponding to ambient air surrounding the vehicle and is typically an accurate reflection of outside air temperature. However, when the vehicle 100 is standing still for a long period of time, or is on a road with a high road surface temp (such as Texas or Arizona), the signal output by the outside air temperature sensor 105 may be influenced by heat from within the engine compartment 138 of the vehicle 100.

The intake air temperature sensor 110 may be mounted on an air intake portion 140 of an engine 145 of the vehicle 100 such as, for example, an intake manifold, an air duct, an air filter housing, etc. The intake air temperature sensor 110 outputs a signal representative of a temperature of air being inducted by the engine 145. The position of the intake air temperature sensor 110 within the engine compartment 138 and a location of an air inlet intake portion 140 results in the intake air temperature sensor 110 outputting a signal that is representative of a temperature of air within the engine compartment 138 when the vehicle 100 is stationary or moving sufficiently slow for a suitable duration of time. The location of the intake air temperature sensor 110 may result in a more accurate reading of air temperature within the engine compartment 138, particularly when the outside air temperature sensor 105 has a relatively less direct exposure to air from within the engine compartment 138 than does the intake air temperature sensor 110. Mounting locations of intake air temperature sensors and operability thereof are known and are not limited to what is described herein.

The ultrasonic sensor 115 is preferably a front facing sensor that is mounted on a front structure of the vehicle 100 such as, for example, the front bumper cover 130 and the bumper cover support 132. In such a configuration the ultrasonic sensors 115 will be exposed to heated air from within the engine compartment 138 when the vehicle 100 is stationary or moving slowly for a suitable duration of time. As such, a temperature of the ultrasonic sensor 115 is subject to significant changes based on vehicle speed and changes in air temperature within the engine compartment 138. Mounting locations of ultrasonic sensors and operability thereof are known and are not limited to what is described herein.

The vehicle speed sensor 118 provides the function of outputting a signal representative of a road speed of the vehicle 100. The vehicle speed sensor 118 may be implemented in several ways. In one example, the vehicle speed sensor 118 is a physical speed sensor that is mounted on a transmission of the vehicle 100. In another example, the vehicle speed sensor 118 is a logical sensor that is integral with a Global Positioning System (GPS) of the vehicle 100. Mounting locations of vehicle road speed sensors and operability thereof are known and are not limited to the examples presented herein.

The engine coolant sensor 102 may be located in the air intake portion 140. The engine coolant sensor 102 is used to monitor the temperature of a coolant in the engine. A throttle position sensor may be used to monitor engine load 104. The throttle position sensor may be mounted on a throttle shaft of a carburetor or throttle body. The throttle position sensor is useful in that it provides several powertrain parameters such as engine load 104, acceleration and deceleration. The throttle position sensor is also useful in determining when the engine is at idle or wide open throttle. Mounting locations of the engine coolant sensor 102 and the throttle position sensor and operability thereof are known and are not limited to the examples presented herein.

In a hybrid electric vehicle, the vehicle may switch between an engine mode and an electric mode. Typically, hybrid battery power and an electric motor are used for engine start/stop and the system switches over to the gas engine when a particular vehicle speed has been met, or when a particular engine power is needed for accelerating or passing. An electronic controller system 125 on the vehicle may provide a signal 106 indicative of whether the vehicle is running in electric mode or gas/diesel engine mode.

The ambient light sensor 108 is used for several lighting applications and climate control applications in the vehicle. The ambient light sensor output may be used to adjust instrument illumination and to turn auto headlamps on and off. Output from the ambient light sensor 108 may also be used when controlling air conditioning in a climate control system 112. The ambient light sensor 108 is typically mounted to the instrument panel inside an occupant cabin 129 of the vehicle 100. Mounting locations of the ambient light sensor and a status indicator for the climate control system are known and are not limited to the examples presented herein.

The signal processing unit 120 is configured for determining a distance between the ultrasonic sensor 115 (or other designated reference location) and an object adjacent to the vehicle 100. Such determination is performed in accordance with a signal strength calibration of the signal processing unit 120 as a function of the signal of the ultrasonic sensor 115. The inventive subject matter accurately estimates temperature of the ultrasonic sensor 115 mounted in an environment of a vehicle where it may be subjected to excessive heat such as from an engine of the vehicle or pavement on which the vehicle is standing still. A more accurate estimate of the ultrasonic sensor temperature results in improved sensor performance as it relates to object detection and distance reporting. At about 40-50° C. a capability of the sensor object detection starts to diminish and worsens as the temperature increases. The inventive subject matter calibrates the sensor based on the temperature of the ultrasonic sensor. Such temperature-dependent adjustment of the ultrasonic sensor signal strength may be increased as a function of an increase in its temperature for the purpose of enhancing sensor operation. The inventive subject matter boosts power output of the sensor to increase sensor signal strength and modifies threshold sensitivities.

The signal processing unit 120 provides the function of processing signals from the outside air temperature 105, the intake air temperature sensor 110, the ultrasonic sensor 115, the vehicle speed sensor 118, the radiator grille block position sensor 119, the engine coolant temperature sensor 102, the engine load sensor 104, the electric mode sensor 106, the ambient light sensor 108 and the air conditioning status sensor in the climate control system 112. The signal processing unit 120 may be mounted on a chassis structure 150 of the vehicle 100. The outside air temperature sensor 105, the intake air temperature sensor 110, the ultrasonic sensor 115 the vehicle speed sensor 118, and the radiator grille block position sensor 119 are individually, and jointly, an example of a second signaling apparatus configured for outputting powertrain operating information. Mounting locations of outside air temperature sensors, intake air temperature sensors, ultrasonic sensors, vehicle road speed sensors and a signal processing unit 120 are well known and are not limited to the examples described herein.

As shown in FIG. 2, the signal processing unit 120 includes a data processing device 133 and memory 137 coupled to the data processing device 133. Sensor signal processing instructions 143 and signal strength threshold calibrations 147 are accessible by the data processing device 133 from the memory 137. In this regard, a skilled person will appreciate methods, processes, and/or operations configured for carrying out ultrasonic sensor calibrating functionality and signal strength boosting as disclosed herein are tangibly embodied by a computer readable medium having instructions thereon that are configured for carrying out such functionality.

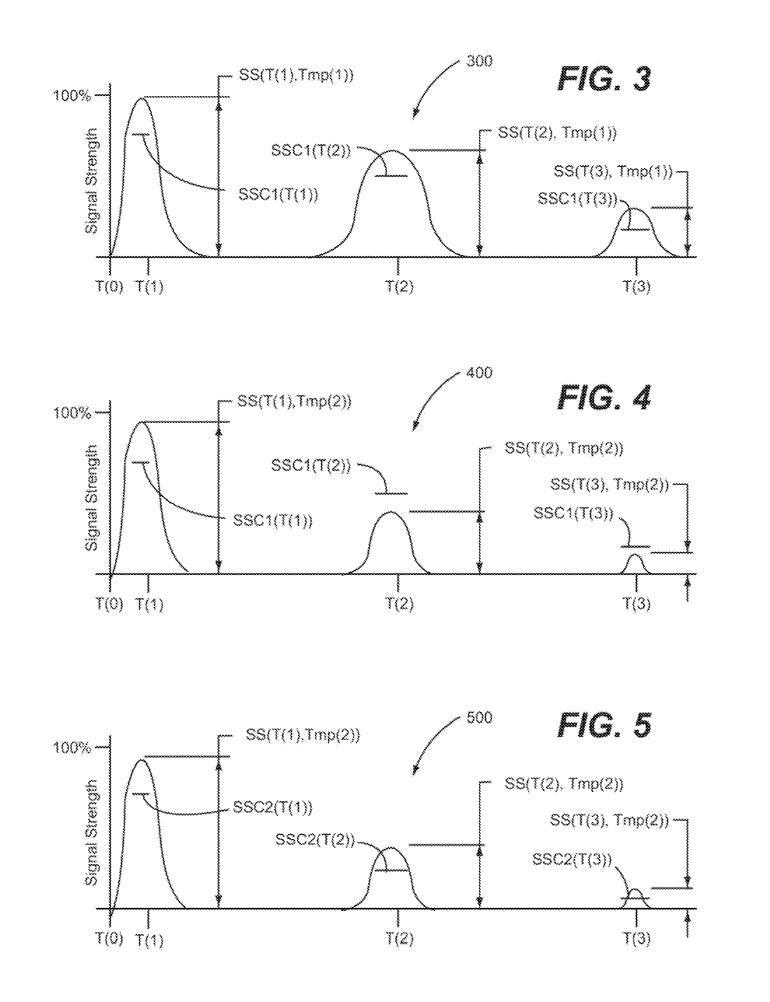

Referring to FIGS. 3-5 object sensing characteristics of a typical ultrasonic sensor as a function of distance and sensor temperature are shown. As is well known, such a typical ultrasonic sensor will emit an acoustic signal of a known frequency and intensity and then sense energy of a reflected acoustic signal generated by the emitted acoustic signal impinging upon and reflecting from an object spaced away from the ultrasonic sensor. By knowing a total round trip time of the emitted and reflected acoustic signals (i.e., time from the sensor to an object being upon which the signal impinges and the time from the object back to the sensor), a distance between the sensor and the object can be determined (i.e., using known constants such as speed of sound through a fluid medium through which the signal is travelling). The ultrasonic sensor will output an electrical signal characterizing energy of the reflected acoustic signal. Examples of such a typical ultrasonic sensor, which are commonly used in automotive applications of object detection and distance ranging, are disclosed in U.S. Pat. Nos. 8,104,351; 8,081,539; 7,343,803; and 6,792,810. The inventive subject matter is not unnecessarily limited to any particular ultrasonic sensor or configuration of ultrasonic sensor.

FIG. 3 is a graph 300 showing an illustrative representation of acoustic response characteristics for a signal outputted by the ultrasonic sensor corresponding to a first signal strength calibration SSC1 (i.e., relatively low sensitivity calibration with respect to available signal strength calibrations) with the ultrasonic sensor being maintained at a first ultrasonic sensor temperature Tmp(1) such as, for example, 25 degrees C. The electrical signal outputted by the ultrasonic sensor represents a relative level of energy within the reflected acoustic signal for the given sensor temperature and signal strength calibration and for a baseline signal output energy. As can be seen, for the given temperature, calibration, and signal output energy conditions, the signal strength calibration values SSC1(T(1)), SSC1 (T(2)) and SSC1(T(3)) at reflected acoustic signal propagation times T(1), T(2) and T(3), respectively, are well below the peak signal strengths SS(T(1)), SS(T(2)) and SS(T(3)) at such times. The reflected acoustic signal propagation time T(0) preferably, but not necessarily, represents a time at which the ultrasonic sensor is energized for causing the emitted acoustic signal to be emitted therefrom. The signal strength calibration values represent a signal strength level at a designated acoustic signal propagation time required for a reflected acoustic signal sensed by the ultrasonic sensor at the same to be designated acoustic signal propagation time to be recorded/recognized as a sensed instance of an object. Therefore, the ultrasonic sensor can provide acceptable signal sensing performance at the given temperature and calibration parameters over sensing distances corresponding to reflected acoustic signal propagation times T(1), T(2) and T(3). In this regard, the signal strength calibration of FIG. 3 is one that enables information outputted from the ultrasonic sensor to provide at least a baseline level of object detecting performance.

FIG. 4 is a graph 400 showing an illustrative representation of acoustic response characteristics for a signal outputted by the ultrasonic sensor corresponding to the first signal strength calibration SSC1 with the ultrasonic sensor being maintained at a second ultrasonic sensor temperature Tmp(2) such as, for example, 50 degrees C. The electrical signal outputted by the ultrasonic sensor represents a relative level of energy within the reflected acoustic signal for the given sensor temperature and signal strength calibration and for the same baseline emitted acoustic signal strength used in association with the illustrative representation of FIG. 3. As can be seen, for the given temperature, calibration, and signal output energy conditions, the signal strength calibration value SSC1(T(1)) at reflected acoustic signal propagation time T(1) is acceptably below the peak signal strength at reflected acoustic signal propagation time T(1). However, for the given temperature, calibration, and signal output energy conditions, the signal strength calibration values SSC1(T(2)) and SSC1(T(3)) at reflected acoustic signal propagation times T(2) and T(3), respectively, are not acceptably below the peak signal strength at reflected acoustic signal propagation times T(1) and T(2)). Therefore, the ultrasonic sensor can provide acceptable signal sensing performance at the given temperature and calibration parameters over sensing distance corresponding to reflected acoustic signal propagation time T(1), but not over sensing distances corresponding to reflected acoustic signal propagation times T(2) and T(3). The resulting performance of the ultrasonic sensor at the conditions of FIG. 4 would be underreporting of objects at distances corresponding to reflected acoustic signal propagation times T(2) and T(3).

FIG. 5 is a graph 500 showing an illustrative representation of acoustic response characteristics for a signal outputted by the ultrasonic sensor corresponding to a second signal strength calibration SSC2 (i.e., relatively high sensitivity calibration with respect to the first signal strength calibration) with the ultrasonic sensor being maintained at the second ultrasonic sensor temperature Tmp(2) such as, for example, 50 degrees C. The electrical signal outputted by the ultrasonic sensor represents a relative level of energy within the reflected acoustic signal for the given sensor temperature and signal strength calibration and for the same baseline emitted acoustic signal strength used in association with the illustrative representations of FIGS. 3 and 4. As can be seen, for the given temperature, calibration, and signal output energy conditions, the signal strength calibration values SSC2(T(1)), SSC2(T(2)) and SSC2(T(3)) at reflected acoustic signal propagation times T(1), T(2) and T(3), respectively, are well above the peak signal strengths at such times. Therefore, the ultrasonic sensor can provide acceptable signal sensing performance at the given temperature and calibration parameters over sensing distances corresponding to reflected acoustic signal propagation times T(1), T(2) and T(3). In this regard, the signal strength calibration of FIG. 5 is one that enables information outputted from the ultrasonic sensor to provide at least a baseline level of object detection performance.

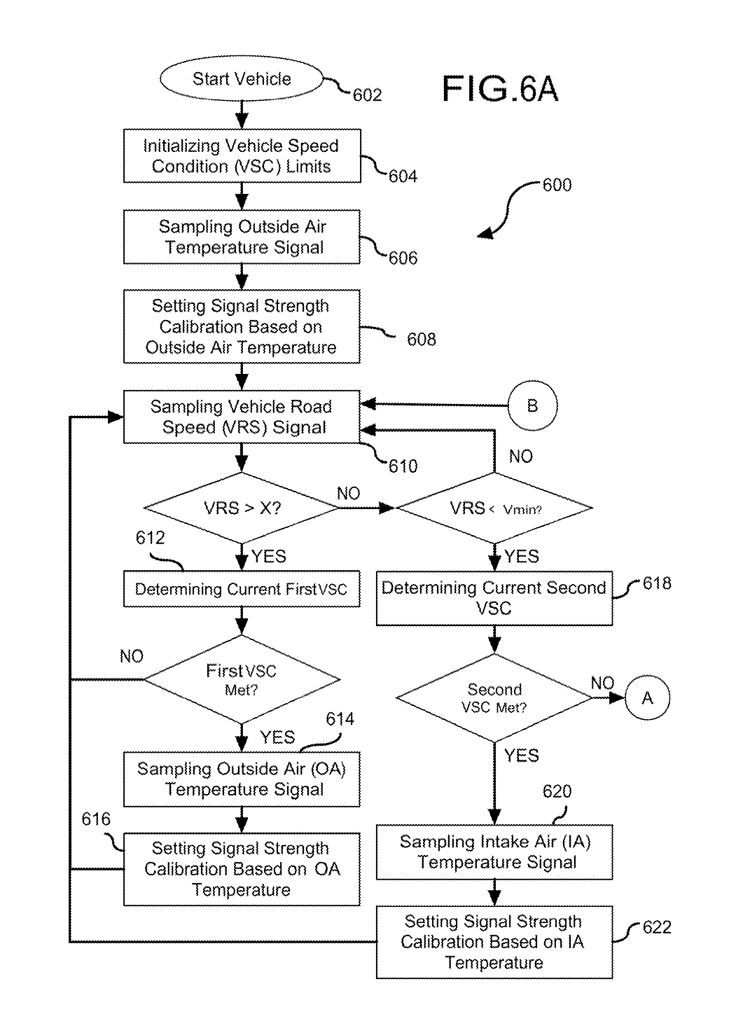

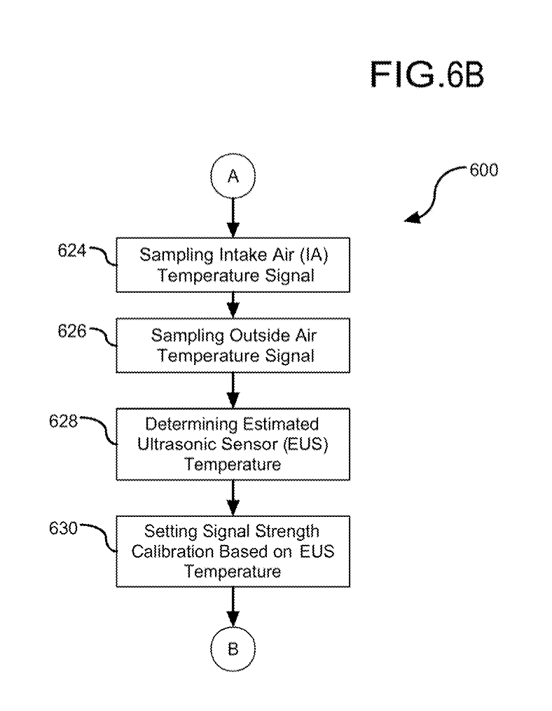

A method 600 for implementing ultrasonic sensor calibrating functionality is shown in FIGS. 6A and 6B. The method 600 allows a signal strength calibration used in processing an electrical signal outputted by an ultrasonic sensor (e.g., voltage indicating energy of a reflected acoustic signal) to be selected dependent upon temperature of the ultrasonic sensor. Advantageously, the method 600 provides for a more accurate temperature of an ultrasonic sensor mounted in an environment of a vehicle that is subjected to excessive heat such as from an engine of a vehicle or pavement on which the vehicle is standing still. By more accurately determining the temperature of an ultrasonic sensor, it is possible to provide improved sensor performance as it relates to object detection and distance reporting. The method 600 is an example of an algorithm to estimate the ultrasonic sensor's temperature using various temperature information that is available from existing temperature sensors of the vehicle. In the specific example of an ultrasonic sensor that is mounted in or near an engine compartment of a vehicle and that is exposed to outside airflow when the vehicle is moving (e.g., mounted on a front bumper cover of the vehicle), an estimate of the ultrasonic sensor's temperature is made using a signal from an outside air temperature sensor and/or a signal from an intake air temperature sensor.

Referring to FIG. 6A, after an operation 602 is performed for starting the vehicle, an operation 604 is performed for initializing any vehicle speed condition (VSC) limits, as necessary. For example, as will be discussed below, some vehicle speed conditions can include counters and the like that need to be initialized at the onset of a current drive cycle or engine operation cycle. An operation 606 is then performed for sampling the signal from the outside air temperature sensor for determining a current outside air temperature, followed by an operation 608 being performed for setting a signal strength calibration based on the current outside air temperature (i.e., the temperature corresponding to the current outside air temperature sensor signal). This is an example of a first instance of signal strength calibration. Setting the signal strength calibration can include setting (e.g., adjusting) calibration information associated with signal reception sensitivity, setting (e.g., adjusting) output power of an object sensing signal of the ultrasonic sensor, or both. For example, in addition to adjusting the signal strength calibration for signal reception (e.g., as discussed above in reference to FIGS. 3-5), the output power of the ultrasonic sensor can be increased to maintain a uniform sound pressure level of the object sensing signal. Furthermore, it is disclosed herein that, in other embodiments, the operation 608 of setting the signal strength calibration could be based on a different air temperature (e.g., the intake air temperature).

After the signal strength calibration is set, an operation 610 is performed for sampling a vehicle road speed (VRS) signal for determining a current road speed of the vehicle. If the current vehicle road speed is less than a first vehicle speed threshold X (e.g., 30 mph) and is greater than a minimum vehicle speed threshold Vmin (e.g., 5 mph), the method 600 continues at the operation 610 for sampling the vehicle road speed (VRS) signal for determining a next instance of the current road speed of the vehicle. Otherwise, if the current vehicle road speed is greater than the first vehicle speed threshold X (e.g., 30 mph), an operation 612 is performed for determining a first vehicle speed condition based on the current vehicle road speed and the first vehicle speed threshold X. When the first vehicle speed condition is met, the method 600 continues with an operation 614 for sampling the signal from the outside air temperature sensor for determining a current outside air temperature and then an operation 616 is performed for setting the signal strength calibration based on the current outside air temperature (i.e., the temperature corresponding to the current outside air temperature sensor signal). Otherwise, if the first vehicle speed condition is not met, the method 600 continues at the operation 610 for sampling the vehicle road speed (VRS) signal for determining a next instance of the current road speed of the vehicle.

The first vehicle speed condition allows certain assumptions about the current temperature of the ultrasonic sensor to be made. Through such assumptions, a signal strength calibration that enhances performance of the ultrasonic sensor at its current temperature can be set (e.g., selected from a plurality of available signal strength calibrations) and utilized in processing signal strength signals received by a signal processing unit, for example, from the ultrasonic sensor. In some embodiments of determining the first vehicle speed condition, a first counter is used for assessing how long the vehicle has been above the first vehicle speed threshold X (e.g., a counter that quantifies an aggregate time that the vehicle road speed is above the first vehicle speed threshold X). For example, each time the vehicle road speed is sampled and found to be above the first vehicle speed threshold X, this first counter is incremented by a given amount (e.g., +1). In this manner, the first counter can be used to confirm a vehicle speed condition in which a current speed of the vehicle has been greater than the first vehicle speed threshold for a duration of time longer than a first prescribed time threshold (e.g., a first time at-speed threshold) thereby supporting the signal strength calibration being set (e.g., selected from a plurality of available signal strength calibrations) based on a predefined temperature criteria such as, for example, the current outside air temperature. As will be discussed below in reference to a second vehicle speed threshold Vmin, a second counter that is used for assessing how long the vehicle has been below the second vehicle speed threshold Vmin is decremented by a given amount (e.g., −1) in response to the first counter being incremented. In this regard, the second counter quantifies an aggregate time that the vehicle road speed is below the second vehicle speed threshold Vmin. As necessary, the first and second counters can be reset to respective initial values and/or precluded from exceeding respective limits thereof.

Referring back to the operation 610 for sampling the vehicle road speed (VRS) signal for determining a next instance of the current road speed of the vehicle, if the current vehicle road speed is less than the first vehicle speed threshold X and is less than the minimum vehicle speed threshold Vmin, the method 600 continues at an operation 618 for determining a second vehicle speed condition based on the current vehicle road speed and the minimum vehicle speed threshold Vmin (i.e., a second vehicle speed threshold). When the second vehicle speed condition is met, the method 600 continues with an operation 620 for sampling the signal from the intake air temperature sensor for determining a current intake air and then an operation 622 is performed for setting the signal strength calibration based on the current intake air temperature (i.e., the temperature corresponding to the intake air temperature signal). This is an example of a second instance of the signal strength calibration. Otherwise, as will be discussed below, the method 600 continues with implementing signal strength calibration based on an estimated temperature of the sensor as a function of both the outside air temperature and intake air temperature.

Similar to the first vehicle speed condition, the second vehicle speed condition allows certain assumptions about the current temperature of the ultrasonic sensor to be made. Through such assumptions, a signal strength calibration that enhances performance of the ultrasonic sensor at its current temperature can be set (e.g., selected from a plurality of available signal strength calibrations) and utilized in processing signal strength signals received by a signal processing unit, for example, from the ultrasonic sensor. As discussed above in the discussion relating to the first vehicle speed condition, in some embodiments of determining the second speed condition, a second counter is used for assessing how long the vehicle has been below the second vehicle speed threshold Vmin (e.g., a counter that quantifies an aggregate time that the vehicle road speed is below the second vehicle speed threshold Vmin). As previously disclosed above, each time the vehicle road speed is sampled and found to be below the second vehicle speed threshold Vmin, this second counter is incremented by a given amount (e.g., +1). In this manner, the second counter can be used to confirm a vehicle speed condition in which a current speed of the vehicle has been less than the second vehicle speed threshold for a duration of time longer than a second prescribed time threshold (e.g. a second time at-speed threshold) thereby supporting the signal strength calibration being set (e.g., selected) based on a predefined temperature criteria such as, for example, the current intake air temperature. In conjunction with incrementing the second counter, the first counter can also be decremented by a given amount (e.g., −1). For example, in the context of the flow diagram shown in FIG. 6A, when a counter corresponding to the first vehicle speed threshold X is increased a counter corresponding to the second vehicle speed threshold Vmin is correspondingly decreased.

As disclosed above and referring to FIG. 6B, the method 600 continues with setting the signal strength calibration based on an estimated temperature of the sensor as a function of both the outside air temperature and intake air temperature when neither the first nor second vehicle speed conditions are met. In this manner, a third vehicle speed condition is met when neither the first nor second vehicle speed conditions have been met. This third vehicle speed condition represents a transitional condition between a driving condition and a stopped/slow speed condition in which a current vehicle speed is below the first vehicle speed threshold X and is above the second vehicle speed threshold Vmin, but does not meet the second vehicle speed condition.

As shown in FIG. 6B, setting the signal strength calibration based on an estimated temperature of the sensor as a function of both the outside air temperature and intake air temperature includes an operation 624 being performed for sampling the signal of the intake air temperature sensor and operation 626 being performed for sampling the signal of the outside air temperature sensor. The sequence in which such sampling is performed is not essential. It is disclosed herein that sampling the signal of the outside air temperature sensor (i.e. OAT) can include generating a composite OAT value that is a function of both an unfiltered OAT value (OAT-U) and a filtered OAT value (OAT-F). Proportioning of the unfiltered OAT value and the filtered OAT value can be based on considerations such as speed of the vehicle, time the vehicle has been at a given actual or average speed, etc. The filtered OAT value is a value that is generated using an algorithm to reduce the effect of under hood heat and road heat on ambient air temperature. This filtered OAT value is often already available to vehicle systems as it is used for displaying a stable OAT value (e.g., on a dashboard display) that does not exhibit short duration swings associated with proximity/exposure of the OAT sensor to under hood heat and road heat. The unfiltered (i.e., raw) OAT temperature value is that which represents the signal as outputted from the OAT sensor and from which the filtered OAT value is derived.

Thereafter, an operation 628 is performed for determining the estimated ultrasonic sensor temperature as a function of both the current intake air temperature (i.e., the temperature corresponding to the intake air temperature signal) and the current outside air temperature (i.e., the temperature corresponding to the outside air temperature signal). In one implementation, determining the ultrasonic sensor temperature includes determining a temperature offset as a function of the intake air temperature sensor signal and the outside air temperature sensor signal and then adding the temperature offset to a temperature corresponding to the outside air temperature sensor signal. One example of the temperature offset is the product between an offset constant (e.g., determined by experimentation for a given vehicle) and a difference between a temperature corresponding to the intake air temperature sensor signal and a temperature corresponding to the outside air temperature sensor signal. However, embodiments of the inventive subject matter are not unnecessarily limited to any particular approach for estimating the ultrasonic sensor temperature as a function of both the intake air temperature sensor signal (or a corresponding intake air temperature represented thereby) and the outside air temperature sensor signal (or a corresponding outside air temperature represented thereby).

It is disclosed herein that estimation of the ultrasonic sensor temperature can be based on information other than or in addition to the aforementioned air temperature sensor information. For example, estimation of the ultrasonic sensor temperature can be based on heat transfer calculations from powertrain components can be used. Information upon which such heat transfer calculations are a function include, but are not limited to, coolant temperature information, load/power information, road speed information, mile per gallon (MPG) booster radiator block engaged information, and the like. In this regard, embodiments of the inventive subject matter can utilize any and all available information available within an electronic controller system or other system of a vehicle to estimate ultrasonic sensor temperature.

In one specific example of implementing ultrasonic sensor calibrating functionality using information other than only air temperature sensor information, coolant temperature is used along with outside air temperature and intake air temperature for setting signal strength calibration. Specifically, the operation 624 discussed above in reference to FIG. 6B is modified to perform an operation (or a plurality of operations) for sampling an intake air temperature signal and an engine coolant temperature signal (i.e., powertrain operating information) and the subsequent operation 628 is modified such that determining the estimated ultrasonic temperature is based on the intake air temperature signal, the engine coolant temperature signal and the OAT signal. Powertrain operating information used in setting thresholds can be determined under controlled conditions using a dynamometer. The sampled value corresponding to the OAT signal can be the aforementioned composite OAT value. Thus, at the operation 630, setting the signal strength calibration based on the estimated ultrasonic temperature will be based on the a value corresponding to the OAT temperature signal, a value corresponding to the coolant temperature signal, and a value corresponding to the intake air temperature signal. This is an example of a second instance of the signal strength calibration. For example, the signal strength calibration can be adjusted accordingly (i.e., for enhanced sensitivity) if the value corresponding to the OAT temperature signal is greater than an OAT Threshold, the value corresponding to the coolant temperature signal is greater than an engine coolant temp threshold and the value corresponding to the intake air temperature signal is greater than an intake air temperature threshold.

The intake air temperature value can be derived as a function of a greater proportion of outside ambient air temperature (i.e., from an IAT sensor) and a smaller proportion of engine compartment air temperature (e.g., from the OAT sensor). For example, depending on vehicle speed, the intake air temperature value can include mostly engine compartment at very slow speeds (indicative of engine bay temp) but at higher speeds reflects more outside air temp. If a vehicle is stopped or going slow, the coolant temp value can be weighted more heavily in estimating ultrasonic sensor temperature. The reverse is true for switching to a lower sensitivity threshold including an equation component to account for hysteresis. Such hysteresis component of the equation is included so that the system is not overly sensitive and thereby picking up ground reflections. The underlying objective of the manner in which ultrasonic sensor calibrations are set is to maintain threshold levels needed to see objects but not be so sensitive that it also sees ground reflections from road cracks, small rocks, etc.

It is well known that some vehicles have a radiator grille block that can be selectively closed for reducing aerodynamic draft and thereby increasing fuel efficiency (i.e., sometimes referred to as a mile per gallon (MPG) booster radiator block). Position (i.e., state) information of the actuator used to transition the radiator grille block between its open position (i.e., allowing air to flow freely through the grille such as when the vehicle is stationary) to its closed position (i.e., limiting airflow through the grille such as when the vehicle is travelling at a high rate of speed) can be used in estimating temperature of the ultrasonic sensor. For example if the vehicle is driven over a certain amount of speed with radiator grille block in its open position and with coolant temperature and OAT falling below their respective thresholds for a prescribed duration of time, it can be assumed that the ultrasonic sensor calibrations need to be switched back to baseline settings (i.e., for a baseline ultrasonic sensor temperature) as opposed to being set for enhanced sensitivity. To this end, the operation 624 discussed above in reference to FIG. 6B is modified such that sampling of the powertrain operating information further includes radiator grille block position duration of time. In this respect, cooling effect of the engine bay and thermal properties on the sensor are being assessed during a non-zero speed sensor soak with gas engine running as the intake air temperature signal becomes less accurate as an indicator of engine bay temperature after the vehicle has been moving for a period of time.

The above mentioned embodiments of the inventive subject matter are specifically configured for vehicles having an internal combustion engine in a running state under a hood of the vehicle. However, it is disclosed herein that the inventive subject matter can be embodied in a manner specifically configured for a full electric vehicle or for a hybrid electric vehicle having an engine that is not in a running state that would cause under hood heat of an amount that would affect ultrasonic temperature performance. In such embodiments, under hood heat is not a consideration.

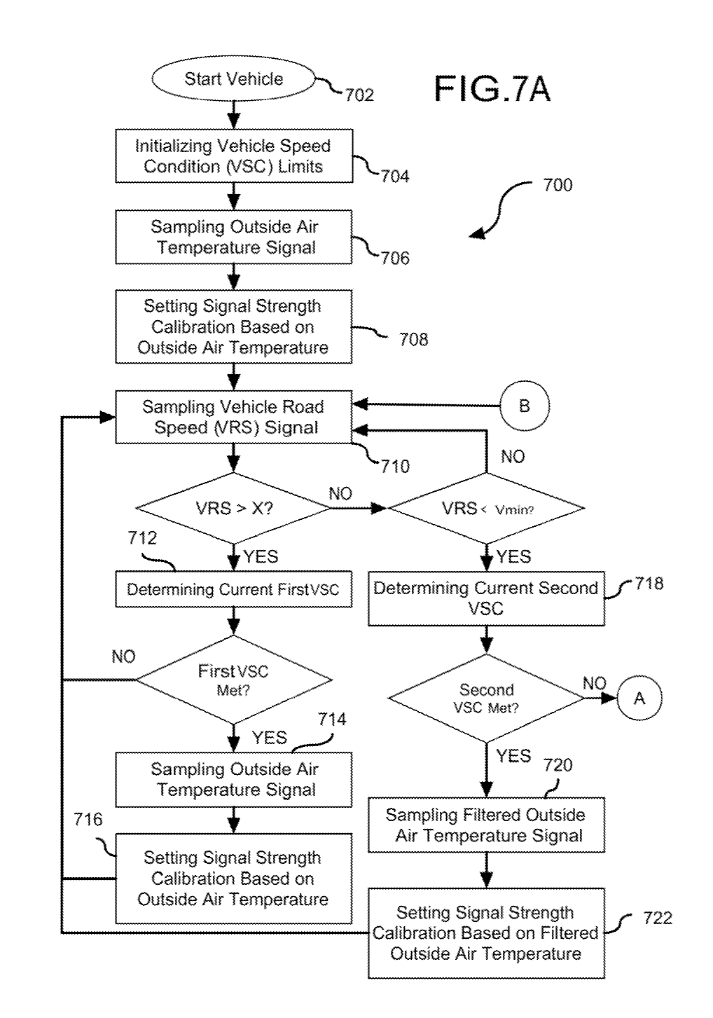

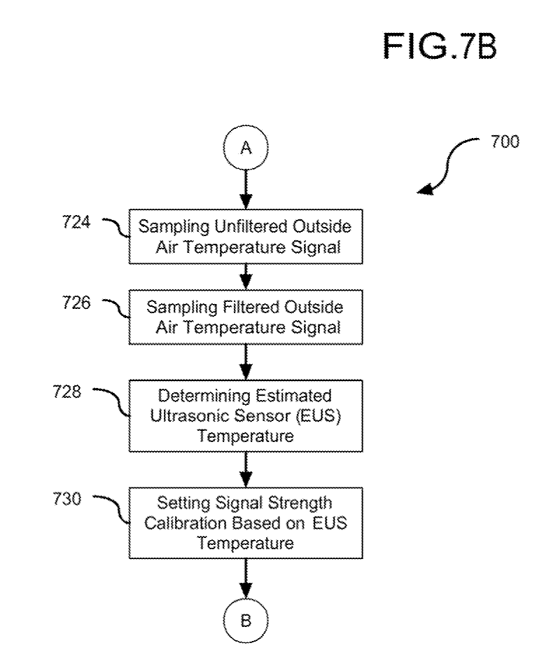

A method 700 for implementing ultrasonic sensor calibrating functionality in a vehicle running in an electric mode (e.g., a full electric vehicle or a plug-in hybrid) is shown in FIGS. 7A and 7B. The method 700 allows a signal strength calibration used in determining a power output level of an object sensing signal from an ultrasonic sensor and/or used in processing an electrical signal outputted by the ultrasonic sensor in response to receiving a reflected portion of the object sensing signal (e.g., voltage indicating energy of a reflected acoustic signal) to be set (e.g., selected) dependent upon an estimated temperature of the ultrasonic sensor. Advantageously, the method 700 provides for a more accurate temperature of an ultrasonic sensor mounted in an environment of a vehicle that is subjected to excessive heat such as from pavement on which the vehicle is travelling over. By more accurately determining the temperature of an ultrasonic sensor, it is possible to provide improved sensor performance as it relates to object detection and distance reporting. The method 700 is an example of an algorithm to estimate the ultrasonic sensor's temperature using various temperature information that is available from existing temperature sensors of the vehicle. In the specific example of an ultrasonic sensor that is exposed to outside airflow when the vehicle is moving (e.g., mounted on a front bumper cover of the vehicle), an estimate of the ultrasonic sensor's temperature is made using a signal from a signal representing an unfiltered outside air temperature and/or a signal representing a filtered outside air temperature.

Referring to FIG. 7A, after an operation 702 is performed for energizing the vehicle, an operation 704 is performed for initializing any vehicle speed condition (VSC) limits, as necessary. For example, as will be discussed below, some vehicle speed conditions can include counters and the like that need to be initialized at the onset of a current drive cycle or engine operation cycle. An operation 706 is then performed for sampling the signal from the outside air temperature sensor for determining a current unfiltered outside air temperature, followed by an operation 708 being performed for setting a signal strength calibration based on the current outside air temperature (i.e., the temperature corresponding to the raw current outside air temperature sensor signal). Setting the signal strength calibration can include setting (e.g., adjusting) calibration information associated with signal reception sensitivity, setting (e.g., adjusting) output power of an object sensing signal of the ultrasonic sensor, or both. For example, in addition to adjusting the signal strength calibration for signal reception (e.g., as discussed above in reference to FIGS. 3-5), output power of the ultrasonic sensor can be increased to maintain a uniform sound pressure level of the object sensing signal.

After the signal strength calibration is set, an operation 710 is performed for sampling a vehicle road speed (VRS) signal for determining a current road speed of the vehicle. If the current vehicle road speed is less than a first vehicle speed threshold X (e.g., 30 mph) and is greater than a minimum vehicle speed threshold Vmin (e.g., 5 mph), the method 700 continues at the operation 710 for sampling the vehicle road speed (VRS) signal for determining a next instance of the current road speed of the vehicle. Otherwise, if the current vehicle road speed is greater than the first vehicle speed threshold X (e.g., 30 mph), an operation 712 is performed for determining a first vehicle speed condition based on the current vehicle road speed and the first vehicle speed threshold X. When the first vehicle speed condition is met, the method 700 continues with an operation 714 for sampling the signal from the outside air temperature sensor for determining a current unfiltered outside air temperature and then an operation 716 is performed for setting the signal strength calibration based on the current outside air temperature (i.e., the temperature corresponding to the current raw outside air temperature sensor signal). Otherwise, if the first vehicle speed condition is not met, the method 700 continues at the operation 710 for sampling the vehicle road speed (VRS) signal for determining a next instance of the current road speed of the vehicle. It is disclosed herein that the outside air temperature of the operations 706, 708, 712 and 714 can be raw outside air temperature signal that has been processed such as, for example with certain diagnostic plausibility checks, rules, etc. thereby producing is lightly filtered (i.e., a baseline processed outside air temperature signal) in regard to a more highly filtered outside air temperature signal as discussed below.

The first vehicle speed condition allows certain assumptions about the current temperature of the ultrasonic sensor to be made. Through such assumptions, a signal strength calibration that enhances performance of the ultrasonic sensor at its current temperature can be set (e.g., selected from a plurality of available signal strength calibrations) and utilized in processing signal strength signals received by a signal processing unit, for example, from the ultrasonic sensor. In some embodiments of determining the first vehicle speed condition, a first counter is used for assessing how long the vehicle has been above the first vehicle speed threshold X (e.g., a counter that quantifies an aggregate time that the vehicle road speed is above the first vehicle speed threshold X). For example, each time the vehicle road speed is sampled and found to be above the first vehicle speed threshold X, this first counter is incremented by a given amount (e.g., +1). In this manner, the first counter can be used to confirm a vehicle speed condition in which a current speed of the vehicle has been greater than the first vehicle speed threshold for a duration of time longer than a first prescribed time threshold (e.g., a first time at-speed threshold) thereby supporting the signal strength calibration being set (e.g., selected from a plurality of available signal strength calibrations) based on a predefined temperature criteria such as, for example, the current outside air temperature. As will be discussed below in reference to a second vehicle speed threshold Vmin, a second counter that is used for assessing how long the vehicle has been below the second vehicle speed threshold Vmin is decremented by a given amount (e.g., −1) in response to the first counter being incremented. In this regard, the second counter quantifies an aggregate time that the vehicle road speed is below the second vehicle speed threshold Vmin. As necessary, the first and second counters can be reset to respective initial values and/or precluded from exceeding respective limits thereof.

Referring back to the operation 710 for sampling the vehicle road speed (VRS) signal for determining a next instance of the current road speed of the vehicle, if the current vehicle road speed is less than the first vehicle speed threshold X and is less than the minimum vehicle speed threshold Vmin, the method 700 continues at an operation 718 for determining a second vehicle speed condition based on the current vehicle road speed and the minimum vehicle speed threshold Vmin (i.e., a second vehicle speed threshold). When the second vehicle speed condition is met, the method 700 continues with an operation 720 for sampling a signal providing a filtered representation of the outside air temperature (i.e., the filtered outside air temperature) for determining a current filtered outside air temperature and then an operation 722 is performed for setting the signal strength calibration based on the current filtered outside air temperature. Otherwise, as will be discussed below, the method 700 continues with implementing signal strength calibration based on an estimated temperature of the sensor as a function of both the unfiltered outside air temperature and filtered outside air temperature. It is disclosed herein that the operation for sampling the signal providing the filtered representation of the outside air temperature can be replaced with an operation for deriving the filtered representation of the outside air temperature using the unfiltered outside air temperature signal.

Similar to the first vehicle speed condition, the second vehicle speed condition allows certain assumptions about the current temperature of the ultrasonic sensor to be made. Through such assumptions, a signal strength calibration that enhances performance of the ultrasonic sensor at its current temperature can be set (e.g. selected from a plurality of available signal strength calibrations) and utilized in processing signal strength signals received by a signal processing unit, for example, from the ultrasonic sensor. As discussed above in the discussion relating to the first vehicle speed condition, in some embodiments of determining the second speed condition, a second counter is used for assessing how long the vehicle has been below the second vehicle speed threshold Vmin (e.g., a counter that quantifies an aggregate time that the vehicle road speed is below the second vehicle speed threshold Vmin). As previously disclosed above, each time the vehicle road speed is sampled and found to be below the second vehicle speed threshold Vmin, this second counter is incremented by a given amount (e.g., +1). In this manner, the second counter can be used to confirm a vehicle speed condition in which a current speed of the vehicle has been less than the second vehicle speed threshold for a duration of time longer than a second prescribed time threshold (e.g., a second time at-speed threshold) thereby supporting the signal strength calibration being set (e.g., selected) based on a predefined temperature criteria such as, for example, the current intake air temperature. In conjunction with incrementing the second counter, the first counter can also be decremented by a given amount (e.g., −1). For example, in the context of the flow diagram shown in FIG. 7A, when a counter corresponding to the first vehicle speed threshold X is increased a counter corresponding to the second vehicle speed threshold Vmin is correspondingly decreased.

As disclosed above and referring to FIG. 7B, the method 700 continues with setting the signal strength calibration based on an estimated temperature of the sensor as a function of both the unfiltered outside air temperature and filtered outside air temperature when neither the first nor second vehicle speed conditions are met. In this manner, a third vehicle speed condition is met when neither the first nor second vehicle speed conditions have been met. This third vehicle speed condition represents a transitional condition between a driving condition and a stopped/slow speed condition in which a current vehicle speed is below the first vehicle speed threshold X and is below the second vehicle speed threshold Vmin, but does not meet the second vehicle speed condition.

As shown in FIG. 7B, setting the signal strength calibration based on an estimated temperature of the sensor as a function of both the unfiltered outside air temperature and filtered outside air temperature includes an operation 724 being performed for sampling the unfiltered outside air temperature signal and operation 726 being performed for sampling the filtered outside air temperature signal (or otherwise determining the filtered outside air temperature). The sequence in which such sampling is performed is not essential. Thereafter, an operation 728 is performed for determining the estimated ultrasonic sensor temperature as a function of both the unfiltered outside air temperature and the filtered outside air temperature. In this regard, a composite outside air temperature value that is a function of both the unfiltered outside air temperature and the filtered outside air temperature is generated. Proportioning of the unfiltered outside air temperature and the filtered outside air temperature can be based on considerations such as speed of the vehicle, time the vehicle has been at a given actual or average speed, etc. The filtered outside air temperature can be a value that is generated using an algorithm to reduce the effect of road heat on ambient air temperature. A signal representing this filtered outside air temperature is often already available to vehicle systems as it is used for displaying a stable outside air temperature value (e.g., on a dashboard display) that does not exhibit short duration swings associated with proximity/exposure of the outside air temperature sensor to road heat. The unfiltered (i.e., raw) outside air temperature value is that which represents the signal as outputted from the outside air temperature sensor and from which the filtered outside air temperature value is derived.

The method described with reference to FIGS. 7A and 7B is specific to a full electric or a hybrid electric vehicle having an engine that is not in a running state that would cause under hood heat of an amount that would affect ultrasonic temperature performance. Using a mix, i.e., an average, of filtered and unfiltered outside air temperature, temperature changes with the effect of sun load on pavement surface temperature as the speed of sound changes through air based on temperature provide a more accurate estimate of temperature changes without showing a constantly varying higher rate temperature to the vehicle operator by way of the center stack. For example, outside air temperature estimates are filtered appropriately to specific powertrain systems and engine types, (e.g., hybrid, non-hybrid, gas, diesel, etc.). A filtered outside air temperature average of a temperature signal that best matches estimated sensor temperature for a specific vehicle program is used to determine an estimate for ultrasonic temperature sensor and will also give an accurate outside air temperature to the driver.

While the estimate for ultrasonic temperature sensor will also give an accurate outside air temperature to the driver, there are instances in which the outside air temperature displayed to the driver should not be updated as frequently as the systems that use the estimate for other purposes. The strategy for displaying an outside air temperature according to the inventive subject matter may be broken down into 5 categories for vehicle conditions. By addressing each possible vehicle condition, according to its own unique characteristics, an accurate outside air temperature may be displayed to a vehicle driver without unnecessary fluctuations that not only cause confusion for the driver, but may adversely affect other vehicle systems that rely on outside air temperature for their operation, such as estimation of the ultrasonic sensor temperature.

A first category for vehicle conditions is when the vehicle is starting from a “cold” engine such as when a vehicle has been parked for an extended period of time, (i.e., overnight). A second category for vehicle conditions is when the vehicle is starting from a “hot” engine, such as after a vehicle has been running for a while, the ignition has been turned off and the engine is restarted within a short period of time. A third category for vehicle conditions is when the vehicle has been parked in an area, such as a garage setting or a parking structure, having an ambient temperature that is lower than a temperature outside. A fourth category for vehicle behavior is when the vehicle has been parked in an area, such as a garage setting, having an ambient temperature that is higher than a temperature outside, the vehicle is started and transitions to the area having a lower outside air temperature. And a fifth category addresses updating the outside air temperature displayed to a driver while the vehicle is being driven, either at a speed above the first vehicle speed condition, or during stop and go operations.

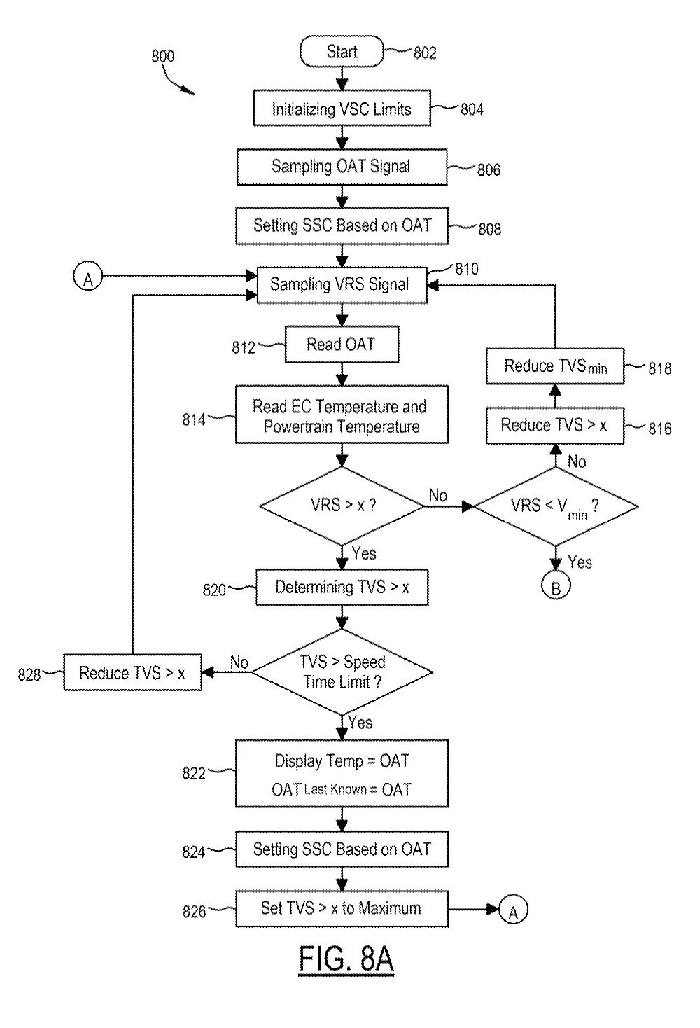

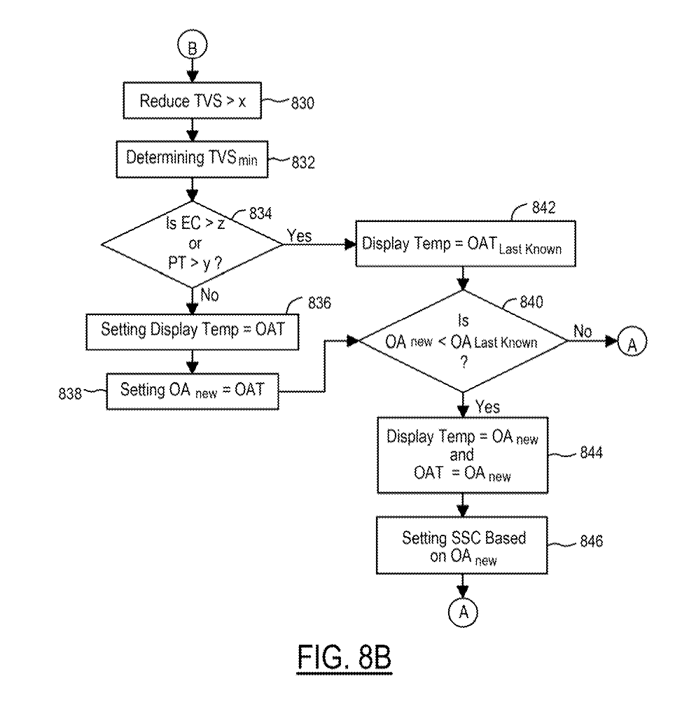

The inventive subject matter for displaying the outside air temperature (OAT) to the driver, and implementing ultrasonic sensor calibrating functionality for at least the vehicle behaviors described above, is shown in FIGS. 8A and 8B. As discussed above, while the currently estimated OAT may be the most accurate to use for ultrasonic sensor calibration, it may or may not be the most accurate to display to the driver. The methods described above with reference to FIGS. 6A, 6B, 7A and 7B allow a signal strength calibration used in determining a power output level of an object sensing signal from an ultrasonic sensor and/or used in processing an electrical signal outputted by the ultrasonic sensor in response to receiving a reflected portion of the object sensing signal (e.g., voltage indicating energy of a reflected acoustic signal) to be set (e.g., selected) dependent upon an estimated temperature of the ultrasonic sensor. Advantageously, the method 800 also provides for a more accurate outside air temperature to display to a driver of a vehicle that is subjected to, not only excessive heat such as from pavement on which the vehicle is traveling over, the garage that the vehicle may be parked in, but also including other outside air influences, such as heat generated by the engine in the engine compartment. The method described in FIGS. 8A and 8B provides a reliable method for displaying an outside air temperature that remains stable and does not exhibit swings associated with proximity or exposure of the outside air temperature sensor to road heat or engine compartment heat.

The method 800 is an example of an algorithm that determines when to use an estimate of the ultrasonic sensor's temperature using various temperature information that is available from existing temperature sensors of the vehicle. In the specific example of an ultrasonic sensor that is exposed to outside airflow when the vehicle is moving (e.g., mounted on a front bumper cover of the vehicle), an estimate of the ultrasonic sensor's temperature is made using a signal from a signal representing an outside air temperature, a signal representing an engine coolant temperature and a signal representing a powertrain temperature. Other signals used in the algorithm include signals representing other powertrain parameters, such as a powertrain temperature and engine load, a signal representing an engine “on/off” or “electric” mode, a signal representing sun load, and a signal representative of a state of a climate control system on the vehicle.

Through vehicle testing and experimentation using a dynamometer, a vehicle engine load may be controlled along with a cell temperature. As engine coolant temperature and other input temperatures rise, signals are monitored to determine “tipping points”, such as those discussed with reference to FIGS. 3-5. The signals monitored may include signals such as engine load, sun load, a status of the engine mode, and a status of the climate control system. Ultrasonic object detection is also monitored to determine “tipping points”, such as those discussed with reference to FIGS. 3-5. In addition to the “tipping points” for the ultrasonic sensors, these signals may also be used to determine a more accurate display of outside air temperature that is to be provided to the driver and described herein with reference to FIGS. 8A and 8B.

Referring to FIG. 8A, after an operation 802 is performed for energizing the vehicle, an operation 804 is performed for initializing any vehicle speed condition (VSC) limits as necessary. For example, as will be discussed below, some vehicle speed conditions may include counters (TVS>X, TVSₘᵢₙ) and the like that may need to be initialized at the onset of a current drive cycle or engine operation cycle. An operation 806 is then performed for sampling the signal from the outside air temperature sensor, OAT, followed by an operation 808 being performed for setting a signal strength calibration (SSC) based on the current outside air temperature (OAT) (i.e., the temperature corresponding to the current outside air temperature signal).

After the signal strength calibration is set, an operation 810 is performed for sampling a vehicle road speed (VRS) signal for determining a current road speed of the vehicle. And another operation 812 is performed for sampling an outside air temperature (OAT). The operations 806 and 812 may involve adjustments to the outside air temperature due to the effects of heat from the engine compartment as described with reference to FIGS. 6A, 6B, 7A, and 7B and the first and second vehicle speed conditions described earlier herein.

An operation 814 is performed for sampling signals representative of an engine coolant temperature and a powertrain temperature. If the current vehicle road speed is less than the first vehicle speed threshold, X, (e.g., 30 mph) and is greater than a minimum vehicle speed threshold, Vmin, (e.g., 5 mph), then a first VSC has not been met, and the method 800 performs an operation 816 to reduce a counter representative of the time that the vehicle speed is less than the first vehicle speed threshold. The method 800 performs an operation 818 to reduce a counter tracking the time that the vehicle speed is greater than a minimum vehicle speed, Vmin. Each of the counters may be reduced by one, but should not drop below zero. The method 800 then continues at the operation 810 for again sampling the vehicle road speed signal for determining the next instance of the current road speed of the vehicle. The operations described to this point reflect the first category of vehicle conditions described above, for example, when the vehicle has been parked long enough for the engine to cool, is restarted, and is moving faster than a minimum vehicle speed, Vmin, but slower than the first vehicle road speed threshold, X.

In the event the current vehicle road speed is less than the first vehicle speed threshold, X and is less than a minimum vehicle speed threshold, Vmin, a second vehicle speed condition (VSC) has been met and the method continues as shown in FIG. 8B to be discussed later herein for a second vehicle speed condition. The operations described with reference to FIG. 8B will apply to the second category of vehicle conditions described above. For example, when the vehicle has been parked for a period of time that is not long enough for the engine to cool.

Otherwise, if the current vehicle road speed (VRS) is greater than the first vehicle speed threshold X, the first vehicle speed condition has been met and an operation 820 is performed for determining an amount of time, TVS>X, that the current vehicle road speed (VRS) exceeds the speed threshold, X. If VRS>X for a predetermined amount of time the method 800 continues with an operation 822 for determining that a temperature to be displayed to a driver is the outside air temperature (OAT) sampled at operation 812 (i.e., the temperature corresponding to the current outside air temperature sensor signal) and a value for a last known outside air temperature, OA_{lastknown} is also set to OAT and stored in memory. An operation 824 is performed to set the detection criteria and distance corrections (SSC) for the ultrasonic sensor based on the outside air temperature sampled at operation 812. An operation 826 is performed setting the counter (TVS>X) tracking the time the vehicle speed has exceeded the first vehicle speed threshold to a maximum value and continues at operation 810.

If the time limit has not been met, the method 800 then performs an operation 828 to reduce the counter tracking the time that the first vehicle speed condition is not met and continues at the operation 810 for sampling the vehicle road speed (VRS) signal for determining a next instance of the current road speed of the vehicle.

Referring back to the operation 810 for sampling the vehicle road speed (VRS) signal for determining a next instance of the current road speed of the vehicle. Operations 812 and 814 are repeated. If the next instance of the current vehicle road speed is still less than the first vehicle speed threshold, X, and is less than the minimum vehicle speed threshold, Vmin, the method 800 continues as described in FIG. 8B. These operations coincide with the categories where a vehicle is transitioning from an environment, such as a garage, where the temperature of the environment may be higher or lower than the outside air temperature. Referring now to FIG. 8B, an operation 830 is performed for reducing the counter tracking the time that the current vehicle road speed is greater than the first vehicle speed threshold (TVS>X). An operation 832 is performed for determining the time that the vehicle speed has been less than the minimum vehicle speed, TVSₘᵢₙ.

Similar to the first vehicle speed condition, the second vehicle speed condition allows certain assumptions about the current temperature of the ultrasonic sensor to be made. Through such assumptions, a signal strength calibration that enhances performance of the ultrasonic sensor at its current temperature can be set and utilized in processing signal strength signals received by a signal processing unit, for example, from the ultrasonic sensor. As discussed above in the discussion relating to the first vehicle speed condition, a second counter may be used for assessing how long the vehicle has been below the second vehicle speed threshold Vmin (e.g., a counter that quantifies an aggregate time that the vehicle speed is below the second vehicle speed threshold, Vmin). As previously disclosed above, each time the vehicle road speed is sampled and found to be below the vehicle speed threshold. Vmin, the second counter is incremented by a given amount (e.g., +1). In this manner, the second counter can be used to confirm a vehicle speed condition in which a current speed of the vehicle has been less than the second vehicle speed threshold for a duration of time longer than a second prescribed time threshold (e.g., a second at-speed threshold) thereby supporting the signal strength calibration being set (e.g., selected) based on a predefined temperature criteria such as, for example, the current intake air temperature. In conjunction with incrementing the second counter, the first counter may also be decremented by a given amount (e.g., −1). For example, in the context of the flow diagram shown in FIG. 8A, when a counter corresponding to the first vehicle speed threshold, X, is increased a counter corresponding to the second vehicle speed threshold, Vmin, is correspondingly decreased and when the counter TVS>X corresponding to the first vehicle speed threshold, X, is decreased, the counter TVSₘᵢₙ corresponding to the second vehicle speed threshold, Vmin, is correspondingly increased. In this regard, the counters jointly maintain criteria that define the first vehicle speed condition being met and the second vehicle speed condition being met.

For the second vehicle speed condition, an operation 834 is performed to consider the signals representing the engine coolant and the powertrain temperature that were sampled at step 810. If one, or more, of the signals is less than or equal to a respective threshold temperature, Z, Y, an operation 836 is performed to set the display temperature equal to the outside air temperature read in step 812. An operation 838 is then performed to save the outside air temperature to memory as a new outside air temperature (OA_{new}).

An operation 840 is performed to compare the new outside air temperature, OA_{new} to the last known air temperature previously stored in memory, OA_{lastknown}. If there is a drop in outside air temperature from the previous value. OA_{new}<OA_{lastknown} then the method 800 will perform an operation 844 to immediately update the outside air temperature on the display to the new outside air temperature and update the outside air temperature (OA) to be used for the sensor calibrations and thresholds settings to the new outside air temperature OA_{new} 846. This describes the categories associated with a vehicle that is transitioning from an area, such as a garage, having an outside air temperature that is either higher or lower than the actual outside air temperature. The inventive subject matter regulates the outside air temperature that will be displayed to the driver in a manner that eliminates unnecessary fluctuations in the temperature being displayed to the driver. When the outside air temperature is lower than the last known outside air temperature, the display will be updated rapidly. When the outside air temperature is higher than the last known outside air temperature, the display will be updated in a slower fashion, taking more time to determine a more accurate outside air temperature.

Referring back to the operation 834 comparing the engine coolant temperature (EC) and the powertrain temperature (PT) to their respective threshold values, when one or more of the temperatures exceeds their respective threshold temperature, the method continues on with an operation 842 that is performed to set the display temperature to the last known outside air temperature, OA_{lastknown}.

An operation 840 is performed to compare the new outside air temperature (OA_{new}) to the last known outside air temperature (OA_{lastknown}). If the new outside air temperature (OA_{new}) is less than the last known outside air temperature (OA_{lastknown}), then an operation 844 is performed to set the display temperature and the outside air temperature setting OAT to the new outside air temperature (OA_{new}). An operation 846 is performed for setting the detection criteria and distance corrections for the ultrasonic sensor to the new outside air temperature OA_{new}.

If the new outside air temperature is greater than or equal to the last known outside air temperature, then the method returns to operation 810 in FIG. 8A for sampling the vehicle road speed signal for the next vehicle speed condition.

In the foregoing specification, the invention has been described with reference to specific exemplary embodiments. Various modifications and changes may be made, however, without departing from the scope of the inventive subject matter as set forth in the claims. The specification and figures are illustrative, rather than restrictive, and modifications are intended to be included within the scope of the inventive subject matter. Accordingly, the scope of the invention should be determined by the claims and their legal equivalents rather than by merely the examples described.

For example, the steps recited in any method or process claims may be executed in any order and are not limited to the specific order presented in the claims. The equations may be implemented with a filter to minimize effects of signal noises. Additionally, the components and/or elements recited in any apparatus claims may be assembled or otherwise operationally configured in a variety of permutations and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

The terms “comprise”, “comprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the inventive subject matter, in addition to those not specifically recited, may be varied or otherwise particularly adapted to specific environments, manufacturing specifications, design parameters or other operating requirements without departing from the general principles of the same.

1. A method for processing, in a signal processing unit, a signal representative of an outside air temperature to be displayed to a driver of a vehicle, comprising the steps of:
providing the signal processing unit with a first instance of an outside air temperature;
providing the signal processing unit with a first instance of powertrain operating information;
determining a vehicle operating condition requiring alteration of the signal representative of an outside air temperature to be displayed;
providing the signal processing unit with a second instance of the outside air temperature in response to determining the vehicle operating condition requiring alteration of the signal representative of the outside air temperature to be displayed; and
displaying the second instance of the outside air temperature to the driver of the vehicle.

2. The method as claimed in claim 1 wherein the outside air temperature is a composite outside air temperature value that is a function of both an unfiltered outside air temperature value and a filtered outside air temperature value.

3. The method as claimed in claim 2 further comprising the step of proportioning the unfiltered outside air temperature value and the filtered outside air temperature value as a function of the powertrain operating information.

4. The method as claimed in claim 1 wherein the vehicle operating condition includes at least one of:
an engine coolant temperature that is greater than a predetermined threshold value;
a powertrain temperature that is greater than a predetermined threshold value;
a vehicle speed signal that indicates a vehicle speed greater than a predetermined vehicle speed threshold value;
a vehicle speed signal that indicates a vehicle speed less than a minimum vehicle speed threshold value;
a time that the vehicle speed has been greater than a predetermined vehicle speed threshold value; and
a time that the vehicle speed has been less than the minimum vehicle speed threshold value.

5. The method as claimed in claim 4 wherein the step of determining a vehicle operating condition requiring alteration of the signal representative of an outside air temperature to be displayed further comprises the steps of:
determining the vehicle road speed is less than a first vehicle road speed threshold,
determining that the vehicle road speed has been less than a minimum vehicle road speed for a predetermined amount of time;
determining at least one of the engine coolant temperature or the powertrain temperature are greater than the respective predetermined threshold value; and
determining when the second instance of the outside air temperature has dropped below a last known outside air temperature stored in a memory of the signal processor.

6. The method as claimed in claim 5 further comprising the step of providing the signal processing unit with a signal strength calibration for an ultrasonic sensor on the vehicle that is based on the second instance of the outside air temperature.

7. An electronic controller system in a vehicle having at least one data processing device coupled between an ultrasonic sensor, a signaling apparatus configured for outputting outside air temperature information and signaling apparatus configured for outputting powertrain operating information, the system comprising:
instructions causing the at least one data processing device to determine a first instance of signal strength calibration for the ultrasonic sensor based on a last known instance of outside air temperature and a first instance of powertrain operating information;
instructions causing the at least one data processing device to determine a vehicle operating condition requiring alteration of the signal strength calibration for the ultrasonic sensor;
instructions for altering the signal strength calibration for the ultrasonic sensor; and
instructions for altering an outside air temperature to be displayed to a driver of the vehicle.

8. The system as claimed in claim 7 wherein the vehicle operating condition further comprises at least one of:
an engine coolant temperature that is greater than a predetermined threshold value;
a powertrain temperature that is greater than a predetermined threshold value;
a vehicle speed signal that indicates a vehicle speed greater than a predetermined vehicle speed threshold value;
a vehicle speed signal that indicates a vehicle speed less than a minimum vehicle speed threshold value;
a time that the vehicle speed has been greater than a predetermined vehicle speed threshold value; and
a time that the vehicle speed has been less than the minimum vehicle speed threshold value

9. The system as claimed in claim 8 wherein instructions to determine a vehicle operating condition requiring alteration of the signal representative of an outside air temperature to be displayed further comprises:
instructions causing the at least one data processing device to determine the vehicle road speed is less than a first vehicle road speed threshold;
instructions causing the at least one data processing device to determine the vehicle road speed has been less than a minimum vehicle road speed for a predetermined amount of time;
instructions causing the at least one data processing device to determine at least one of the engine coolant temperature or the powertrain temperature are greater than the respective predetermined threshold value; and
instructions causing the at least one data processing device to determine when the second instance of the outside air temperature has dropped below a last known outside air temperature stored in a memory of the signal processor.

10. A method for processing, in a signal processing unit, a signal representative of an outside air temperature to be displayed to a driver of a vehicle, comprising the steps of:
receiving a first instance of an outside air temperature;
setting a signal strength calibration and displaying an outside air temperature based on the first instance of the outside air temperature;
receiving a vehicle road speed signal;
receiving a second instance of outside air temperature
receiving a first instance of powertrain operating information;
determining when a first vehicle speed condition has been met;
setting the signal strength calibration and displaying an outside air temperature based on the second instance of the outside air temperature when the first vehicle speed condition has been met;
when the first vehicle speed condition has not been met, determining when a second vehicle speed condition has been met;
comparing the first instance of powertrain operating information to a predetermined threshold value;
determining when the first instance of powertrain operating information exceeds the predetermined threshold value, displaying the first instance of the outside air temperature;
determining when the first instance of powertrain operating information is at or below the predetermined threshold value, displaying the second instance of outside air temperature;
comparing the second instance of outside air temperature to the first instance of outside air temperature; and
setting the signal strength calibration and displaying an outside air temperature based on the second instance of the outside air temperature when the second vehicle speed condition has been met and the second instance of outside air temperature is less than the first instance of outside air temperature.

11. The method as claimed in claim 10 wherein the step of determining a first vehicle speed condition further comprises the steps of:
determining the vehicle speed is greater than a predetermined vehicle speed threshold value; and
determining that the vehicle speed has exceeded the threshold value for at least a predetermined amount of time.

12. The method as claimed in claim 11 wherein the step of determining a second vehicle speed condition further comprises the steps of:
determining the vehicle speed is less than a minimum vehicle speed threshold value; and
determining the vehicle speed has been less than the minimum vehicle speed threshold value for at least a predetermined amount of time.

13. The method as claimed in claim 10 wherein the step of comparing the first instance of powertrain operating information to a predetermined threshold value further comprises the step of comparing at least one of comparing an engine coolant temperature to a predetermined threshold temperature for an engine coolant and comparing a powertrain temperature to a predetermined threshold temperature for a powertrain temperature.

14. The method as claimed in claim 10 wherein the step of determining when the first instance of powertrain operating information exceeds the predetermined threshold value further comprises the step of determining that at least one of an engine coolant temperature or a powertrain temperature exceeds a respective threshold temperature value.

15. The method as claimed in claim 10 wherein the outside air temperature is a composite outside air temperature value that is a function of both an unfiltered outside air temperature value and a filtered outside air temperature value.

16. The method as claimed in claim 10 further comprising the step of proportioning the unfiltered outside air temperature value and the filtered outside air temperature value as a function of the powertrain operating information.
